(19) United States
(12) Patent Application Publication
(10) Pub. No.: US 2024/0143819 A1
(43) Pub. Date: May 2, 2024

(54) APPARATUSES, SYSTEMS, AND METHODS FOR PROVIDING ACCESS RIGHTS MANAGEMENT IN A BUILDING GRAPH

(71) Applicant: Schneider Electric Buildings Americas, Inc., Carrollton, TX (US)

(72) Inventors: Björn R. Carlsson, Trelleborg (SE); Martin Webrant, Malmö (SE)

(73) Assignee: Schneider Electric Buildings Americas, Inc., Carrollton, TX (US)

(21) Appl. No.: 18/498,115

(22) Filed: Oct. 31, 2023

Related U.S. Application Data
(60) Provisional application No. 63/420,992, filed on Oct. 31, 2022.

(51) Int. Cl. G06F 21/62; G06F 16/2458

(52) U.S. Cl. CPC G06F 21/6218; G06F 16/2458

(57) ABSTRACT

Provided are systems, methods, and devices for providing access control to data of a system. Implementations may include providing an interface, receiving access control information via the interface, the access control information relating to a subset of the data of the system, generating an access control command based at least in part upon the received access control information, processing the access control command to create an external repository which is external to the system, the external repository including the subset of the data of the system, and providing access to at least a portion of the subset of the data of the system to a user.

### RELATED APPLICATION

The present application claims priority to U.S. Provisional Patent Application Ser. No. 63/420,992, filed on Oct. 31, 2022 and entitled APPARATUSES, SYSTEMS, AND METHODS FOR PROVIDING ACCESS RIGHTS MANAGEMENT IN A BUILDING GRAPH, which is incorporated by reference herein in its entirety.

### TECHNICAL FIELD

The present disclosure relates to providing access rights management, for example in relation to graph database information.

### BACKGROUND

Existing systems experience difficulties with providing access control to data. For example, depending upon a particular data storage configuration, it may be difficult or impossible to provide access to only a subset of stored data without providing access to additional, unintended, data. These problems are even more apparent in relation to Building Management Systems (BMSes) for spaces with multiple occupiers of different spaces covered by the BMS (e.g., tenants). Existing BMSes are unable to provide access to end users (e.g., individual tenants of a building or space) for their data without allowing access to the BMS data storage directly or by providing access to all BMS data to the end user. Furthermore, a BMS administrator is unable to limit the types and content of end-user data accessed by end-users if direct access to a BMS data store is provided to end users.

Existing solutions provide access to a mirrored copy of all BMS data relating to a customer, which does not provide a BMS administrator to control access to what information is viewable by end users such as individual tenants of a customer. Furthermore, mirrored copies of BMS data might provide only static snapshots of data, and thus may be outdated or inaccurate.

### SUMMARY

It is desirable to provide building tenants with access to Building Management System (BMS) data that corresponds to their space(s). According to aspects of the present disclosure, apparatuses, systems, and methods are provided which enable an administrator or user to select a plurality of subjects (such as locations, systems, and/or equipment) in a building graph and/or main repository for access by different tenants. In a traditional graph database, access rights can only be per-user on a complete repository. However, a building may have multiple different tenants that should have access to different parts of the building. Implementations consistent with the present disclosure may enable one or more tenants to have direct access to run queries against the graph database for their own data, without providing the tenant with access to all BMS data.

Implementations consistent with the present disclosure may include a smart SPARQL Protocol and RDF Query Language (SPARQL) query which uses a list of subjects to make it easy for a user to define which part or parts should be accessible for each tenant. By extracting the selected part into a separate repository in the graph database, it is possible to use the limited access system of the graph database to give access to this selection. By grouping different predicates from the used ontologies into child or parent relations, it is possible to generate a SPARQL query easier to understand yet extensible just by adding new predicates as child or parent relations. Connecting a user group in the building management system to a tenant repository in the graph database may be provided.

In a BMS, an administrator or other user may create tenant objects, with a list of selected subjects (e.g., locations, systems, and/or equipment) and credentials for a corresponding repository in graph database. A user group in the BMS can refer to such a tenant object. After this configuration, the administrator or user can run a command in the BMS to create the tenant repositories in the graph database. Then the administrator can run a command in the BMS to populate the tenant repositories in graph with the selected subjects and their children, grandchildren and so on. This may use the smart SPARQL query together with the groups of predicates. When a tenant user logs on to BMS all requests against graph are directed against the repository referred to be the user group. This way the tenant user only has access to their part of the graph. The end user may be given credentials to the graph database which also only give the desired access.

An administrator or user of a BMS is able to provide tenant access control by generating a tenant object using a smart SPARQL query having a group of subjects (such as location(s), system(s), and/or equipment) and may cause the BMS to generate a corresponding repository in a graph database to permit access to one or more tenant's part of the graph database data. This may be implemented via a BMS interface useable by the administrator or user of the BMS.

BMS administrators may to provide access to subsets of BMS data relating to individual tenants while simultaneously being able to prevent access to the BMS data store itself. BMS administrators can limit which BMS data relating to the tenant/space is accessible to an end user.

A method is provided for controlling access to BMS data by end users by generating an external repository for selected BMS tenant data. The external repository is generated using a SPARQL query which is generated based upon data provided by an administrator or other user via the BMS interface.

A BMS interface may allow an administrator or other user to permit access by a tenant to respective tenant BMS data stored in a graph database.

A SPARQL query may be generated based at least in part upon tenant object responsive to one or more tenant subjects provided via the BMS interface (e.g., including specific locations, systems, or equipment).

A SPARQL query/tenant object may be used by the BMS to generate an external mirrored repository for selected BMS tenant data.

The external mirrored repository may be used to protect BMS graph database data by limiting access to only a subset of all BMS graph database data.

Tenant-specific data may be available to end users via an access-controlled mirrored repository.

According to aspects of the present disclosure, provided is a method for providing access control to data of a system. The method includes providing an interface, receiving access control information via the interface, the access control information relating to a subset of the data of the system, generating an access control command based at least in part upon the received access control information, processing the access control command to create an external repository which is external to the system, the external repository including the subset of the data of the system, and providing access to at least a portion of the subset of the data of the system to a user. The access control command may be a SPARQL query. The received access control information may include an identifier of a tenant and one or more entities associated with the tenant. The identifier of the tenant and data corresponding to the one or more entities associated with the tenant may be stored in a graph database. The access control command may be a SPARQL query used to generate a tenant repository as the external repository. The method may include receiving an authentication request from the user and selectively authenticating the user based at least in part upon the authentication request, whereby the providing access to at least a subset of the data of the system to the user is performed based at least in part upon the user being authenticated. The method may include receiving a query from the user, executing the query against the external repository to obtain query result data, and transmitting the query result data to the user. The subset of the data of the system may be BMS data.

According to further aspects of the present disclosure, provided is a method for providing access control to data of a system. The method includes creating a tenant object, generating a tenant repository based at least in part upon the tenant object, populating the tenant repository in a graph database, selectively authenticating a tenant user, receiving a query from the tenant user, performing the query against the tenant repository to generate query response data, and selectively transmitting the query response data to the tenant user. The tenant object may be associated with a SPARQL query. The tenant object may include an identifier of a tenant and one or more entities associated with the tenant. The identifier of the tenant and data corresponding to the one or more entities associated with the tenant may be stored in a graph database. The data of the system may be BMS data stored by a management system.

According to still further aspects of the present disclosure, provided is a system for providing access control to stored data. The system may include a network, a device coupleable to the network, the device configured to receive input from a user and to transmit information via the network, and a management system communicatively coupleable to the network, the management system. The management system may include a management data storage, the management data storage configured to store tenant data, and an interface module configured to generate an interface for interacting with the management system via the network. The management system may receive a tenant object from the device, generate a tenant repository based at least in part upon the tenant object, and populate the tenant repository in a graph database. The management system may receive an authentication request from the device via the network and to selectively authenticate a tenant based at least in part upon the received authentication request. The system may further include an external device. The management system may cause the external device to store the generated repository, and the external device may provide access to the generated repository. The tenant object may be associated with a SPARQL query, and the management system may generate the tenant repository based at least in part upon the SPARQL query. The SPARQL query may be associated with an identifier of a tenant and one or more entities associated with the tenant.

Numerous other objects, features, and advantages of the present invention will be readily apparent to those skilled in the art upon a reading of the following disclosure when taken in conjunction with the accompanying drawings.

### BRIEF DESCRIPTION OF THE DRAWINGS

A more detailed description of the disclosure, briefly summarized above, may be had by reference to various embodiments, some of which are illustrated in the appended drawings. While the appended drawings illustrate select embodiments of this disclosure, these drawings are not to be considered limiting of its scope, for the disclosure may admit to other equally effective embodiments.

FIG. 1 illustrates a partial block diagram of an embodiment according to aspects of the present disclosure.

FIG. 2 illustrates a flowchart representing an embodiment of generating a tenant repository and performing a query against the tenant repository according to aspects of the present disclosure.

FIG. 3 illustrates a flowchart representing an embodiment of generating a tenant repository and providing access control according to aspects of the present disclosure.

Identical reference numerals have been used, where possible, to designate identical elements that are common to the figures. However, elements disclosed in one embodiment may be beneficially utilized on other embodiments without specific recitation.

### DETAILED DESCRIPTION

Implementations consistent with the present disclosure provide apparatuses, systems, and methods for providing access rights management in a building graph. According to aspects of the present disclosure, a user (such as a building administrator or other user) may be enabled to select a subset of graph database information associated with an entity which is used to generate an external data store including at least a part of the subset of graph database information. The external data store may be physically and/or virtually remote from the graph database and may selectively be mirrored and/or configured to contain or reflect current graph database information.

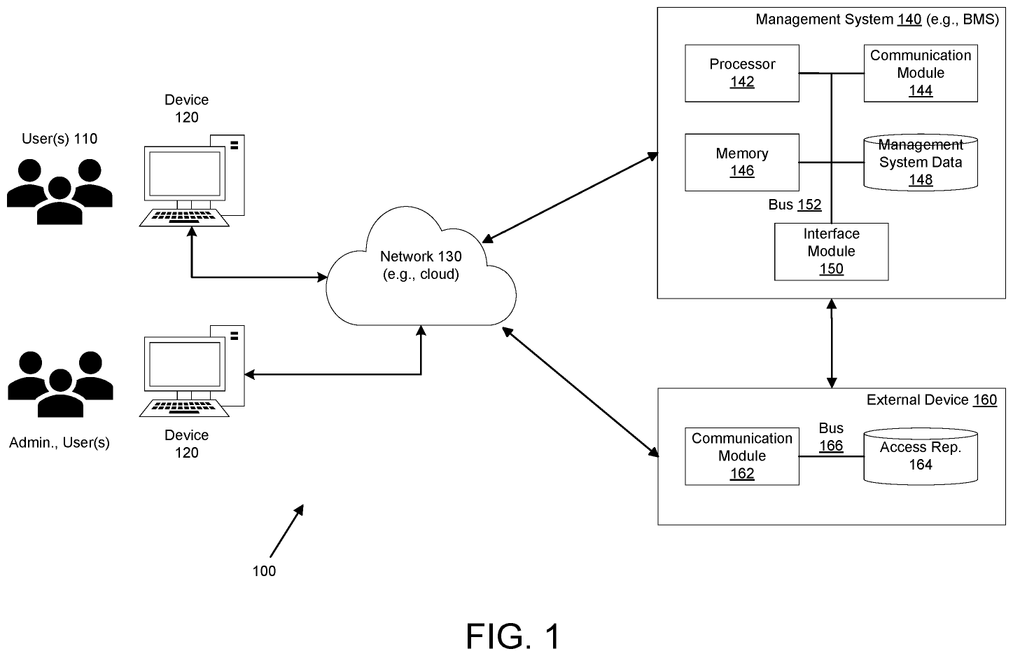

FIG. 1 illustrates a partial block diagram of an embodiment according to aspects of the present disclosure. A system 100 may include one or more of a user 110 associated with a device 120 (e.g., user device), a network 130, a management system 140, and/or an external device 160. It should be appreciated that although only a single device 120, network 130, management system 140, and external device 160 are illustrated by FIG. 1, in various embodiments there may be a plurality of one or more single device 120, network 130, management system 140, and external device 160, and in some embodiments one or more of the single device 120, network 130, management system 140, and external device 160 may not be present. One or more of the device 120, the management system 140, and/or the external device 160 may be communicatively coupleable to the network 130. Additionally or alternatively, two or more of the device 120, the management system 140, and/or the external device 160 may be communicatively coupleable to one another, for example using one or more wired and/or wireless connections (e.g., using respective communication modules of the device 120, the management system 140, and/or the external device 160). In various embodiments, two or more of the device 120, the management system 140, and/or the external device 160 may be coupleable to one another in a daisy chain configuration. Additionally or alternatively, two or more of the device 120, the management system 140, and/or the external device 160 may be communicatively coupleable using one or more wired and/or wireless means, for example via the network 130.

The network 130 may include one or more wired and/or wireless communication mediums communicatively coupleable to one or more of the device 120, the management system 140, and/or the external device 160. The one or more the device 120, the management system 140, and/or the external device 160 may include any electronic device or element capable of communicating with the network 130 and configured to perform at least one operation, store one or more sets of data or information, or to assist in the performance and/or storage of one or more sets of data or information used by or useable by one or more of the device 120, the management system 140, and/or the external device 160. The device 120, the management system 140, and/or the external device 160 may be configured to operate as or otherwise in conjunction with a distributed system, such as a cloud-based storage and/or processing network or system. The network 130 may be any public and/or private network(s), and my include, for example, a local area network (LAN), wide area network (WAN), the Internet, or any other network type or protocol.

The device 120 may be an electronic device capable of performing one or more operations consistent with the present disclosure. The device 120 may be a desktop computer, a laptop, a tablet, a smartphone, or any other electronic device capable of processing and communicating information, or combination(s) thereof. It should be appreciated that the system 100 may include a plurality of devices 120, for example associated with one or more users (such as user 110, a tenant user, and administrator, and/or any other user(s)). The device 120 may include a display section configured to visually convey one or more sets of information to a user thereof. The device 120 may be configured to communicate with one or more of the management system 140 and/or external device 160, for example via one or more wired and/or wireless communications via the network 130. The device 120 may include an application and/or interface (e.g., via a web browser) for obtaining, generating, and/or conveying information associated with the management system 140 (for example, in association with the interface module 150 of the management system 140).

The management system 140 may include one or more of a processor 142, a communication module 144, a memory 146, management data 148, and/or an interface module 150. A conductive bus 152 may be coupled to one or more of the processor 142, communication module 144, memory 146, management data 148, and/or interface module 150, and may be configured to convey one or more sets of information or data between two or more of the processor 142, communication module 144, memory 146, management data 148, and/or interface module 150. Although illustrated as being physically associated with the management system 140, it should be appreciated that one or more of the processor 142, communication module 144, memory 146, management data 148, and/or interface module 150 may be physically and/or logically remote from the management system 140 (either in whole or in part, for example at an external device 160, cloud service environment, and/or other distributed configuration or environment). The processor 142 may be a hardware processor, a software processing element, or combination thereof which is configured to perform one or more operations of the management system, for example in conjunction with the memory 146. The memory 146 may be any volatile and/or non-volatile storage medium configured to store information usable by or in conjunction with the management system 140. In various embodiments, the memory 146 may include one or more sets of instructions executable by the processor 142 to perform at least one operation associated with the management system 140.

The management data 148 may be a database or other data storage element configured to store or otherwise access at least a portion of management data. Management data may include, for example, location data. Location data may include Building Management System (BMS) data. The BMS data may include information relating to one or more spaces. A building or location may be divided into a plurality of sections referred to herein as spaces. The one or more spaces may be respectively associated with one or more tenants. A tenant may be associated with one or more spaces within a location, such as a tenant of one or more spaces within a building associated with the BMS.

The interface module 150 of the management system 140 may be configured to provide access to at least one external user, such as the user 110 of the device 120 via the network 130. The interface module 150 may be configured to provide a portal to the user 110 of the device 120 to access the management system 140. This may include providing a management and/or control interface to the user 110 of the device 120, for example by providing a web interface and/or by providing data useable by the device 120 to visually convey one or more parameters associated with the management system 140 to the user 110 (e.g., via a display unit of the device 120). In various embodiments, the user 110 of the device 120 may access a portal provided by the interface module 150 to select one or more spaces and/or tenants and one or more elements associated with the one or more spaces and/or tenants.

The external device 160 may include one or more of a communication module 162 and/or an access repository 164. The external device 160 may include a conductive bus 166 communicatively coupleable to one or more elements thereof, such as the communication module 162 and access repository 164. Although not illustrated by FIG. 1, it should be understood that the external device 160 may include one or more operational components, such as a hardware processor and/or software processing element, a volatile or non-volatile memory, or the like, to assist in whole or in part to provide one or more operations associated with the external device 160. The external device 160 may be accessible by one or more device 120 and/or by the management system 140, either via direct communication(s) or via the network 130.

The user 110 of the device 120 may be enabled to provide access control information to the management system 140 via the portal associated with the interface module 150. The access control information may relate to a subset of management data associated with the management data 148 (e.g., space and/or tenant data). The access control command is a SPARQL Protocol and RDF Query Language (SPARQL) query. The subset of the data of the system may be BMS data. The management system 140 may be configured to generate an access control command based at least in part upon the access control information received from the user 110 of the device 120, for example using the processor 142 and/or memory 146. The access control command may be processed by the management system 140 to create an external repository. Data stored by the external device 160 may be selectively conveyed to the external device 160 from the management system 140 via the network 130 and/or via direct communication between the management system and the external device 160 (e.g., via one or more wired and/or wireless communication paths). The external repository may be the access repository 164 of the external device 160 in various embodiments. The external device 160 may be external to the management system 140, for example at the external device 160, and may include the subset of data of the system (e.g., space and/or tenant data). The external device 160 may be configured to provide access to at least a portion of the subset of the data of the system to a user, such as a tenant of a space of a BMS, for example using a device 120 associated with the tenant via the network 130.

The management system 140 may be configured to provide location information associated with the external device 160 to a user 110 of the device 120 and/or to a tenant user of a device 120 to access information stored at the access repository 164 or otherwise accessible by the external device 160. Additionally or alternatively, a tenant may access data stored by the access repository 164 and/or otherwise accessible by the external device 160 by accessing the management system 140 via the network 130, for example via the interface module 150 of the management system 140. Access control to data stored at the access repository 164 of one or more external device 160 may be implemented in various embodiments by the external device 160, by the management system 140, or combination thereof. Access control by occupiers such as tenants may be provided, for example, leveraging user or tenant credentials such as a unique identifier and password, multi-factor authentication, or any other mechanism of proving an identity of a user and/or device sufficient to access at least a portion of data associated with the user and/or device.

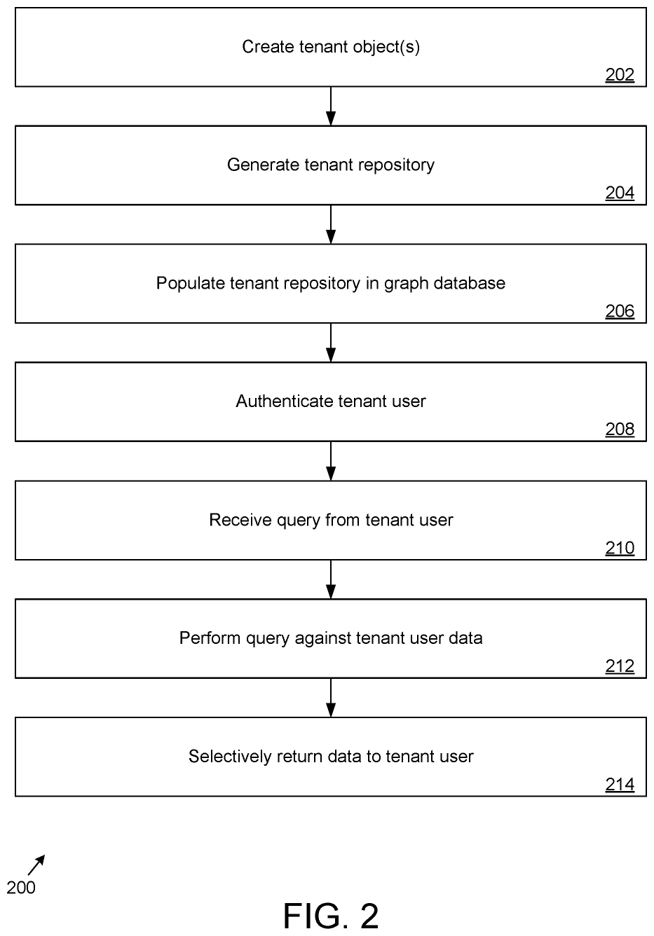

FIG. 2 illustrates a flowchart representing an embodiment of generating a tenant repository and performing a query against the tenant repository according to aspects of the present disclosure. The process 200 includes an operation 202 where one or more tenant objects are created. The one or more tenant objects may be created responsive to an input of a user such as an administrator of a BMS, for example received via the network 130 at the management system 140 via the interface module 150 thereof from a device 120 associated with the BMS administrator or other user. A tenant repository may be generated at an operation 204, for example responsive to at least one tenant object created at operation 202. Although described as a single tenant repository generated at operation 204, it should be appreciated that two or more tenant repositories may be generated at operation 204 without departing from the spirit and scope of the present disclosure, for example where multiple tenant objects are created at operation 202. The generated tenant repository is populated in a graph database at an operation 206. The generated tenant repository may be stored, in whole or in part, at the management system 140 (e.g., at management data 148 or at a local storage of the management system other than the management data 148) and/or at one or more external device 160 (e.g., at an access repository 164 thereof). A tenant user may be authenticated at an operation 208. This may include the tenant user providing a unique identifier and a password or other credentials to the management system 140 and/or external device 160. The management system 140 and/or external device 160 may selectively authenticate the tenant user in accordance with the received identifier(s) and/or credential(s) or may reject access based at least in part upon the received identifier(s) and/or credential(s).

Once a tenant is authenticated and granted access in association with the management system 140, the tenant user may submit a query at an operation 210, for example to the management system 140 and/or external device 160 via the network 130. The management system 140 and/or external device 160 may perform one or more queries against tenant user data at an operation 212 by performing the one or more queries against the generated tenant repository data. One or more sets of data may be returned to the tenant user at an operation 214 responsive to the one or more queries performed at operation 212.

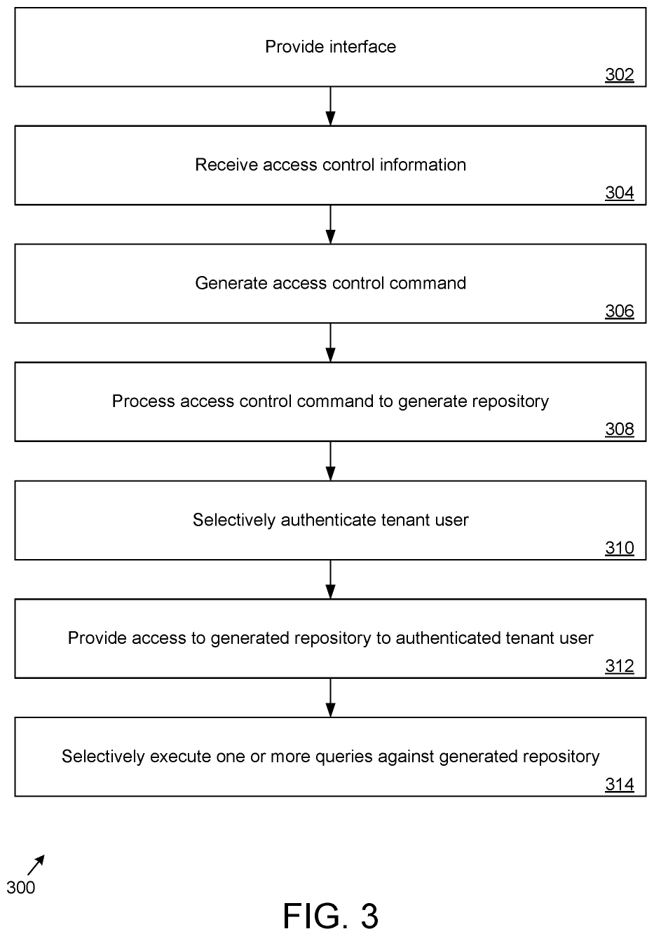

FIG. 3 illustrates a flowchart representing an embodiment of generating a tenant repository and providing access control according to aspects of the present disclosure. The process 300 includes providing an interface at an operation 302. The interface may be provided, for example, using the interface module 150 of the management system 140. The interface may be a network-accessible portal, a website, an accessible data store, or any other accessible entity capable of conveying information, for example via the network 130. Access control information is received at the portal at an operation 304. Access control information may include an identifier of a tenant or space, one or more entities (such as locations, systems, and/or equipment associated with a graph database of the management system 140), and/or any information associated with a managed space, a user, a tenant, or any other useable information. An access control command is generated at an operation 306 according to at least a portion of the access control information received at operation 304. The access control command is a SPARQL query in various embodiments. The access control command is processed at an operation 308 to generate a repository. The generated repository may be a tenant-specific repository including only information associated with the tenant-specific information of the access control command. The generated repository may be stored, in whole or in part, at one or more of the management system 140 and/or external device 160 without departing from the spirit and scope of the present disclosure.

A tenant user may be selectively authenticated at an operation 310. This may include one or more operations described, for example, with reference to operations 208-210 of FIG. 2. An authenticated tenant user may be provided access to the generated repository at an operation 312. The authenticated tenant user may then be permitted to selectively execute one or more queries against the generated repository and to obtain one or more corresponding sets of information in response to the selectively executed one or more queries.

As described herein, provided in various embodiments is a method for providing access control to data of a system. The method includes providing an interface, receiving access control information via the interface, the access control information relating to a subset of the data of the system, generating an access control command based at least in part upon the received access control information, processing the access control command to create an external repository which is external to the system, the external repository including the subset of the data of the system, and providing access to at least a portion of the subset of the data of the system to a user. The access control command may be a SPARQL query. The received access control information may include an identifier of a tenant and one or more entities associated with the tenant. The identifier of the tenant and data corresponding to the one or more entities associated with the tenant may be stored in a graph database. The access control command may be a SPARQL query used to generate a tenant repository as the external repository. The method may include receiving an authentication request from the user and selectively authenticating the user based at least in part upon the authentication request, whereby the providing access to at least a subset of the data of the system to the user is performed based at least in part upon the user being authenticated. The method may include receiving a query from the user, executing the query against the external repository to obtain query result data, and transmitting the query result data to the user. The subset of the data of the system may be BMS data.

According to further aspects of the present disclosure, provided is a method for providing access control to data of a system. The method includes creating a tenant object, generating a tenant repository based at least in part upon the tenant object, populating the tenant repository in a graph database, selectively authenticating a tenant user, receiving a query from the tenant user, performing the query against the tenant repository to generate query response data, and selectively transmitting the query response data to the tenant user. The tenant object may be associated with a SPARQL query. The tenant object may include an identifier of a tenant and one or more entities associated with the tenant. The identifier of the tenant and data corresponding to the one or more entities associated with the tenant may be stored in a graph database. The data of the system may be BMS data stored by a management system.

In various embodiments, provided is a system for providing access control to stored data. The system may include a network, a device coupleable to the network, the device configured to receive input from a user and to transmit information via the network, and a management system communicatively coupleable to the network, the management system. The management system may include a management data storage, the management data storage configured to store tenant data, and an interface module configured to generate an interface for interacting with the management system via the network. The management system may receive a tenant object from the device, generate a tenant repository based at least in part upon the tenant object, and populate the tenant repository in a graph database. The management system may receive an authentication request from the device via the network and to selectively authenticate a tenant based at least in part upon the received authentication request. The system may further include an external device. The management system may cause the external device to store the generated repository, and the external device may provide access to the generated repository. The tenant object may be associated with a SPARQL query, and the management system may generate the tenant repository based at least in part upon the SPARQL query. The SPARQL query may be associated with an identifier of a tenant and one or more entities associated with the tenant.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

The various embodiments disclosed herein may be implemented as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

The flowchart and block diagrams in the Figures illustrate the architecture, functionality and/or operation of possible implementations of various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

We claim:

1. A method for providing access control to data of a system, the method comprising:
providing an interface;
receiving access control information via the interface, the access control information relating to a subset of the data of the system;
generating an access control command based at least in part upon the received access control information;
processing the access control command to create an external repository which is external to the system, the external repository including the subset of the data of the system; and
providing access to at least a portion of the subset of the data of the system to a user.

2. The method of claim 1, wherein the access control command is a SPARQL Protocol and RDF Query Language (SPARQL) query.

3. The method of claim 1, wherein the received access control information includes an identifier of a tenant and one or more entities associated with the tenant.

4. The method of claim 3, wherein the identifier of the tenant and data corresponding to the one or more entities associated with the tenant are stored in a graph database.

5. The method of claim 4, wherein the access control command is a SPARQL query used to generate a tenant repository as the external repository.

6. The method of claim 1, further comprising receiving an authentication request from the user and selectively authenticating the user based at least in part upon the authentication request, whereby the providing access to at least a subset of the data of the system to the user is performed based at least in part upon the user being authenticated.

7. The method of claim 1, further comprising:
receiving a query from the user;
executing the query against the external repository to obtain query result data; and
transmitting the query result data to the user.

8. The method of claim 1, wherein the subset of the data of the system is Building Management System (BMS) data.

9. A method for providing access control to data of a system, the method comprising:
creating a tenant object;
generating a tenant repository based at least in part upon the tenant object;
populating the tenant repository in a graph database;
selectively authenticating a tenant user;
receiving a query from the tenant user;
performing the query against the tenant repository to generate query response data; and
selectively transmitting the query response data to the tenant user.

10. The method of claim 9, wherein the tenant object is associated with a SPARQL Protocol and RDF Query Language (SPARQL) query.

11. The method of claim 9, wherein the tenant object includes an identifier of a tenant and one or more entities associated with the tenant.

12. The method of claim 11, wherein the identifier of the tenant and data corresponding to the one or more entities associated with the tenant are stored in a graph database.

13. The method of claim 11, wherein the data of the system is Building Management System (BMS) data stored by a management system.

14. A system for providing access control to stored data, comprising:
a network;
a device coupleable to the network, the device configured to receive input from a user and to transmit information via the network; and
a management system communicatively coupleable to the network, the management system including,
a management data storage, the management data storage configured to store tenant data; and
an interface module configured to generate an interface for interacting with the management system via the network,
wherein the management system is configured to receive a tenant object from the device, to generate a tenant repository based at least in part upon the tenant object, and to populate the tenant repository in a graph database.

15. The system of claim 14, wherein the management system is configured to receive an authentication request from the device via the network and to selectively authenticate a tenant based at least in part upon the received authentication request.

16. The system of claim 14, wherein the system further comprises an external device, wherein the management system is configured to cause the external device to store the generated repository, the external device configured to provide access to the generated repository.

17. The system of claim 14, wherein the tenant object is associated with a SPARQL Protocol and RDF Query Language (SPARQL) query, and further wherein the management system is configured to generate the tenant repository based at least in part upon the SPARQL query.

18. The system of claim 17, wherein the SPARQL query is associated with an identifier of a tenant and one or more entities associated with the tenant.
